(19) United States
(12) Patent Application Publication
(10) Pub. No.: US 2025/0386916 A1
(43) Pub. Date: Dec. 25, 2025

(54) PATCH FOR COSMETIC CONTAINER AND MOLD FOR MANUFACTURING SAME

(71) Applicant: SHYA HSIN PACKAGING INDUSTRY (CHINA) CO., LTD., Kunshan (CN)

(72) Inventor: Jiajie XU, Kunshan (CN)

(73) Assignee: SHYA HSIN PACKAGING INDUSTRY (CHINA) CO., LTD., Kunshan (CN)

(21) Appl. No.: 18/880,279

(22) PCT Filed: Jun. 29, 2023
(86) PCT No.: PCT/CN2023/103580

§ 371 Date: Dec. 31, 2024

(30) Foreign Application Priority Data
Nov. 23, 2022 (CN) 202223115440.0

(51) Int. Cl. A45D 33/18; B29C 45/33

(52) U.S. Cl. CPC A45D 33/18; B29C 45/33

(57) ABSTRACT

A patch for a cosmetic container and a mold for manufacturing the patch are provided. The patch for the cosmetic container includes a patch substrate formed integrally by a plastic material through injection molding, where the patch substrate includes a first surface and a second surface that are opposite to each other; the first surface includes bumps and recesses that are arranged alternately; a projection of the recess on the second surface is a coupling portion; and the coupling portion is configured to couple the patch and the cosmetic container. The patch for the cosmetic container has a leather-like appearance and a leather touch. By attaching to an outer surface of the cosmetic container, the patch for the cosmetic container not only protects the container, but also gives people a leather impression to improve the product grade.

### CROSS REFERENCE TO THE RELATED APPLICATIONS

This application is the national phase entry of International Application No. PCT/CN2023/103580, filed on Jun. 29, 2023, which is based upon and claims priority to Chinese Patent Application No. 202223115440.0, filed on Nov. 23, 2022, the entire contents of which are incorporated herein by reference.

### TECHNICAL FIELD

The present disclosure relates to the technical field of cosmetic packaging materials, and in particular to a patch for a cosmetic container and a mold for manufacturing the patch.

### BACKGROUND

As daily consumables, cosmetics are widely used. With development of society and constant improvement of human aesthetics, the pursuit of fashion and novelty has become an eternal topic of people. The demand from people on cosmetic containers has been changed from the economical practicability in tradition to high fashion. Traditional cosmetic containers are defective for a single structure and a monotonous style, and cannot meet higher requirements of consumers.

### SUMMARY

In order to overcome the above defects, the present disclosure provides a patch for a cosmetic container. The patch has a leather-like appearance and a leather touch. By attaching to an outer surface of the cosmetic container, the patch not only protects the container, but also gives people a leather impression to improve the product grade.

To solve the technical problems, the present disclosure adopts the following technical solutions:

The present disclosure provides a patch for a cosmetic container, including a patch substrate formed integrally by a plastic material through injection molding, where the patch substrate includes a first surface and a second surface that are opposite to each other; the first surface includes bumps and recesses that are arranged alternately; a projection of the recess on the second surface is a coupling portion; and the coupling portion is configured to couple the patch and the cosmetic container.

Optionally, the bump and the recess adjacent to each other are connected together, and a connecting strip is provided at the deepest position of the recess.

Optionally, a combination of the bump and the recess is a linear structure, a V-shaped structure, a W-shaped structure, a zigzag structure or a wavy structure.

Optionally, both the bump and the recess are arranged along a length direction of the patch substrate, and both the bump and the recess run through the entire or a part of the patch substrate in the length direction.

Optionally, a circle of connecting strip is provided at an edge of a periphery of the first surface.

Optionally, an upper surface of the connecting strip is a smooth and flat plane, or the upper surface of the connecting strip includes a plurality of spaced-apart protrusions.

Optionally, the second surface is a plane as a whole, or the coupling portion is a plane, and a region other than the coupling portion in the second surface is a concave.

Optionally, a symbol is provided on the first surface, the symbol is recessed toward the second surface, or the symbol is protruded from the bump.

Optionally, when the symbol is recessed toward the second surface, the deepest position of the recess is coplanar with an upper surface of the symbol, and the upper surface of the symbol is a smooth and flat plane.

Optionally, a leather grain is provided on the first surface.

Optionally, the patch substrate is a patch substrate made of a thermoplastic polyurethane (TPU) material, a patch substrate made of a polypropylene (PP) material, a patch substrate made of a polyvinyl chloride (PVC) material or a patch substrate made of a polyethylene terephthalate (PET) material.

Optionally, the patch substrate is the patch substrate made of the TPU material, and the TPU material has a density of 1.0 g/cm³ to 1.3 g/cm³, Shore hardness of 60 A to 75 A, a tensile strength of 10 MPa to 20 MPa, a 100% modulus of 1.5 MPa to 2.5 MPa, a 300% modulus of 4 MPa to 6 MPa, an elongation at break of 600% to 800%, a tear strength of 60 KN/m to 70 KN/m, wear resistance of 85 mm³ to 95 mm³, and a glass transition temperature of −45° C. to −40° C.

The present disclosure further provides a mold, where the mold is configured to manufacture the patch for a cosmetic container.

The present disclosure has the following beneficial effects:
1) According to the preset disclosure, the patch includes a patch substrate formed integrally by a plastic material through injection molding. The patch substrate includes a first surface and a second surface that are opposite to each other. The first surface includes bumps and recesses that are arranged alternately. The recess is provided with a connecting strip. A symbol, a leather grain, and other features may further be provided on the first surface. Therefore, the patch has a leather-like appearance and a leather touch. By attaching to an outer surface of the cosmetic container, the patch not only protects the container, but also gives people a leather impression to improve the product grade. Moreover, as an integrally formed piece, the patch has desirable product integrity, and is not damaged and layered easily.
2) Compared with the leather, the patch made of the TPU plastic material is more wear-resistant and elastic. Compared with a traditional product formed by a silicone substrate and a surface imitation leather through punching, the patch has advantages of a simple manufacturing process, a low manufacturing cost, high hardness, strong toughness, and higher durability.

### BRIEF DESCRIPTION OF THE DRAWINGS

FIG. 1 is a top view of a patch according to Embodiment 1 of the present disclosure;

FIG. 2 is an oblique top view of a patch according to Embodiment 1 of the present disclosure;

FIG. 3 is a front view of a patch according to Embodiment 1 of the present disclosure;

FIG. 4 is a left view of a patch according to Embodiment 1 of the present disclosure;

FIG. 5 is a top view of a patch according to Embodiment 2 of the present disclosure;

FIG. 6 is an oblique top view of a patch according to Embodiment 2 of the present disclosure;

FIG. 7 is a front view of a patch according to Embodiment 2 of the present disclosure;

FIG. 8 is a left view of a patch according to Embodiment 2 of the present disclosure;

FIG. 9 is a top view of a patch according to Embodiment 3 of the present disclosure;

FIG. 10 is an oblique top view of a patch according to Embodiment 3 of the present disclosure;

FIG. 11 is a front view of a patch according to Embodiment 3 of the present disclosure;

FIG. 12 is a left view of a patch according to Embodiment 3 of the present disclosure;

FIG. 13 is a top view of a patch according to Embodiment 4 of the present disclosure; and

FIG. 14 is an oblique top view of a patch according to Embodiment 4 of the present disclosure.

In the figures: 10-patch substrate, 20-first surface, 21-bump, and 22-recess; and 23-connecting strip, 24-symbol, and 30-second surface.

### DETAILED DESCRIPTION OF THE EMBODIMENTS

The technical solutions in the embodiments of the present disclosure are clearly and completely described below with reference to the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

It should be noted that the terms “first”, “second”, and so on in the description and claims of this application and in the above accompanying drawings are intended to distinguish similar objects but do not necessarily indicate a specific order or sequence. It should be understood that the objects used in such a way may be exchanged under proper conditions to make it possible to implement the described implementations of this application in sequences except those illustrated or described herein. Moreover, the terms “include”, “have” and their variants mean to cover a non-exclusive inclusion. For example, a process, method, system, product or device that includes a list of steps or units is not necessarily limited to those steps or units which are clearly listed. Instead, they may include other steps or units which are not expressly listed or inherent to such a process, method, product, or device.

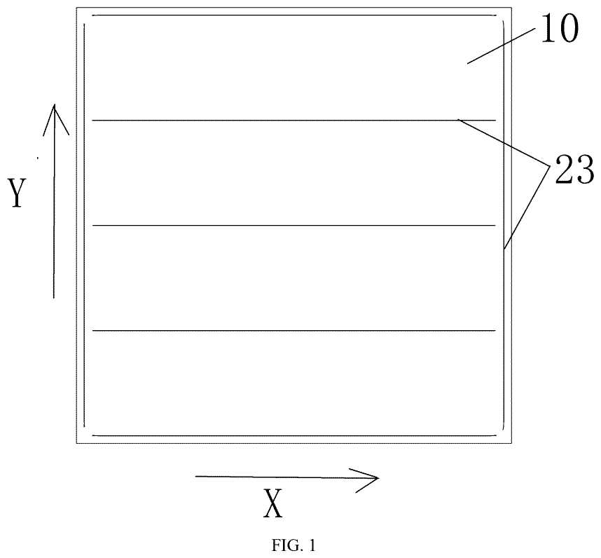

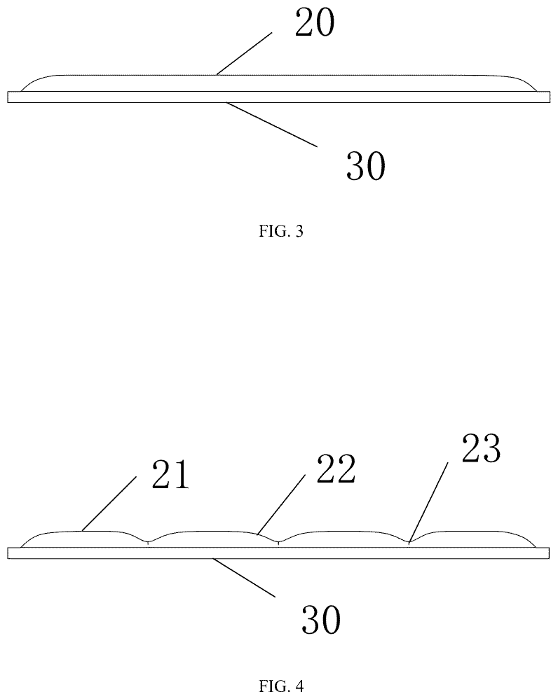

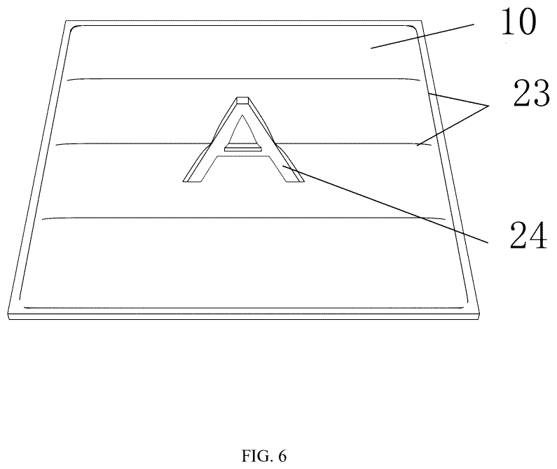

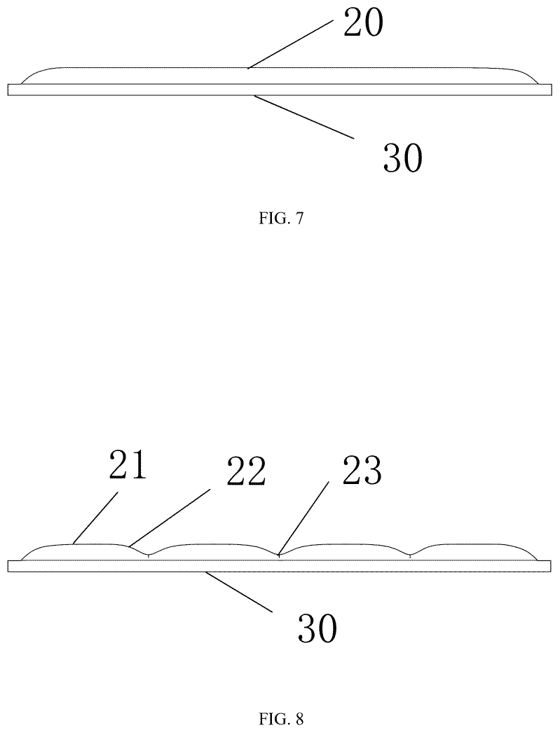

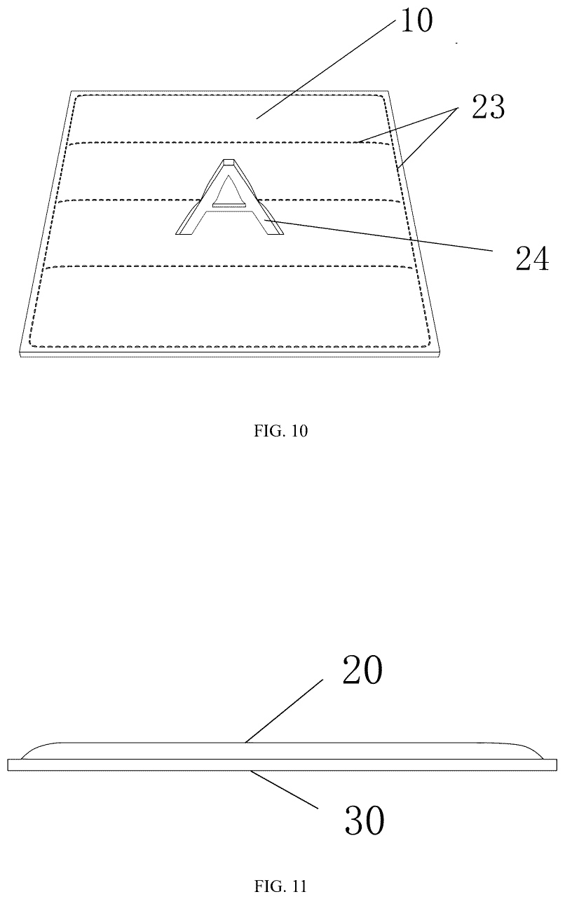

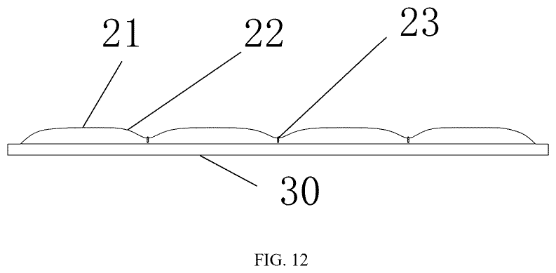

As shown in FIG. 1 to FIG. 14, a patch for a cosmetic container includes patch substrate 10 formed integrally by a plastic material through injection molding. The patch substrate 10 includes first surface 20 and second surface 30 that are opposite to each other. The first surface 20 includes bumps 21 and recesses 22 that are arranged alternately. Projection of the recess 22 on the second surface 30 is a coupling portion. The coupling portion is configured to couple the patch and the cosmetic container. For the patch substrate 10, the first surface 20 serves as an outer surface, the second surface 30 serves as an inner surface, and the coupling portion serves as a part of the second surface 30. Optionally, the coupling portion is a plane. The coupling portion is directly stuck to an outer surface of the cosmetic container through a glue or an adhesive tape, thereby realizing the effect of protecting and decorating the container through the first surface 20. The first surface 20 is the decorative outer surface. A shape of the patch substrate 10 may be adjusted according to a structure of the cosmetic container, and may be, for example, a rectangle, a square, an ellipse, a circle, etc. Besides the patch substrate 10, the patch may further include other assemblies. For example, a protective film may be attached to the first surface 20 of the patch substrate 10 to protect the patch substrate, and an adhesive layer may be attached to the second surface 30 to stick the patch substrate to the surface of the cosmetic container. The patch has a leather-like appearance and a leather touch. By attaching to the outer surface of the cosmetic container, the patch not only protects the container, but also gives people a leather impression to improve the product grade. Compared with the leather, the patch made of the TPU plastic material is more wear-resistant and elastic. Compared with a traditional product formed by a silicone substrate and a surface imitation leather through punching, the patch has advantages of high hardness, strong toughness, and higher durability.

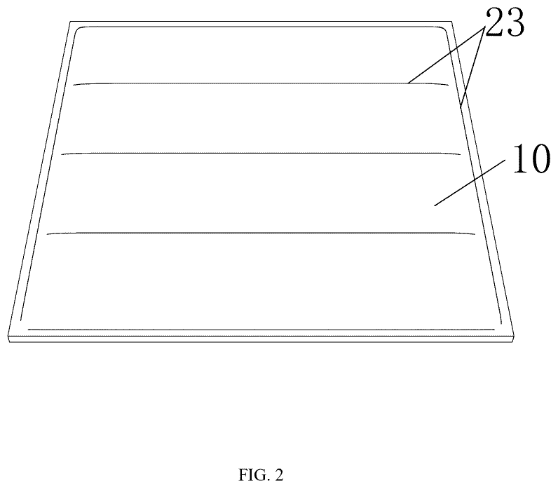

As shown in FIG. 1 to FIG. 2, the bump 21 and the recess 22 adjacent to each other are connected together. Connecting strip 23 is provided at the deepest position of the recess 22. In a possible implementation, the bump 21 and the recess 22 are arranged on the first surface 20. The bump 21 and the recess 22 are arranged continuously, alternately and repeatedly. The connecting strip 23 is provided at the deepest position of the recess 22, namely a lowest point of the recess shown in FIG. 4. The connecting strip 23 is configured to separate the first surface 20 into a plurality of parallel bumps 21. There are four bumps 21 in FIG. 1, and a number of the bumps may be provided freely as needed. Optionally, there may be 3-8 bumps 21. Lengths of the bumps may be the same, and may also be different. Likewise, width of the bumps may be the same, and may also be different. Optionally, an upper surface of the bump 21 is an arc surface protruded toward a direction away from the second surface. An upper surface of the recess 22 is an arc surface recessed toward the second surface. The recess 22 is configured to connect two bumps 21, such that the bumps are transitioned smoothly to form a smooth surface. One connecting strip 23 is provided at the deepest position of the recess 22 to imitate the effect that a middle of the leather is sewed and segmented by a thread.

Optionally, a combination of the bump 21 and the recess 22 is a linear structure, a V-shaped structure, a W-shaped structure, a zigzag structure or a wavy structure. In actual application, the bump 21 and the recess 22 may be shaped in combination with a special shape of the patch. For example, referring to FIG. 1, when the patch is a square structure, the bump 21 and the recess 22 may be designed as the linear structure, the wavy structure, etc. When the patch is a circular structure, the bump 21 and the recess 22 may be designed as the V-shaped structure, the W-shaped structure, etc. Certainly, in order to ensure coordination of the patch, a structure of the connecting strip of the recess 22 is also adjusted correspondingly. Optionally, the bump 21, the recess 22, and the connecting strip 23 are structurally consistent. The bump 21 and the recess 22 may be arranged along a length direction, a width direction or a diagonal direction of the patch substrate. In FIG. 1, the bump 21 and the recess 22 are arranged straightly along the length direction of the patch substrate 10. The bump 21 and the recess 22 may also be rotated 45° clockwise or counterclockwise, such that the bump and the recess are arranged along the diagonal direction of the patch substrate 10. Certainly, the bump and the recess may also be rotated any angle between 0° and 90°. Alternatively, the bump 21 and the recess 22 are rotated 90°, such that the bump and the recess are arranged along the width direction of the patch substrate 10.

Both the bump 21 and the recess 22 are arranged along the length direction of the patch substrate 10, and both the bump 21 and the recess 22 run through the entire or a part of the patch substrate 10 in the length direction. For ease of description, in FIG. 1, an X-axis direction is defined as the length direction of the patch substrate 10, and a Y-axis direction is defined as the width direction of the patch substrate 10. As shown in FIG. 1, both the bump 21 and the recess 22 are arranged along the length direction of the patch substrate 10, and arranged in the whole length direction. That is, along the width direction of the patch substrate 10, the bump 21 and the recess 22 are arranged sequentially and repeatedly, with a same length. FIG. 4 is a left view of the patch. As can be seen from the figure, the first surface 20 is a wavy structure, with an upwardly raised portion being the bump 21, and a downwardly recessed portion being the recess 22. Certainly, the bump 21 and the recess 22 may also be provided on a part of the patch substrate in the length direction. Optionally, a length of the bump 21 (or the recess 22) is a half or more of a total length of the patch substrate.

As shown in FIG. 1 to FIG. 2, a circle of connecting strip 23 is provided at an edge of a periphery of the first surface 20. With the connecting strip 23 at the periphery of the first surface, the product is more durable. The connecting strip at the periphery of the first surface and the connecting strip in the recess are consistent, such that the patch is more beautiful and is closer to the appearance of the leather product.

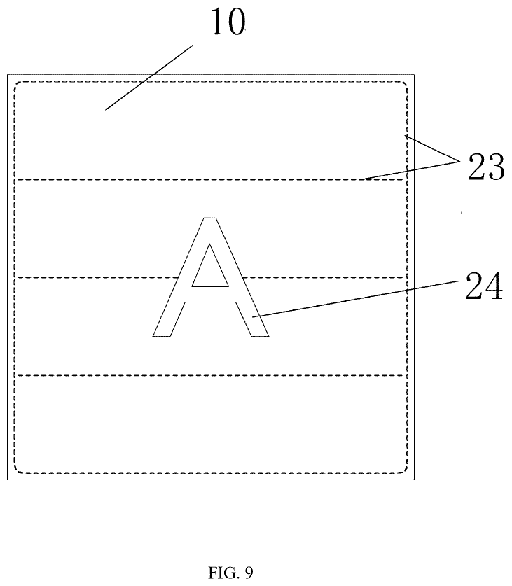

Embodiment 1: As shown in FIG. 1 to FIG. 4, an upper surface of the connecting strip 23 is a smooth and flat plane. Both the upper surface of the connecting strip 23 in the recess 22 and the upper surface of the connecting strip 23 at the periphery of the first surface are the smooth plane, such that the mold for manufacturing the patch of this structure is simpler and has a low manufacturing cost. Alternatively, the upper surface of the connecting strip 23 includes a plurality of spaced-apart protrusions. The connecting strip 23 is a microprotrusion array. Embodiment 3: As shown in FIG. 9 to FIG. 12, both the connecting strip 23 in the recess and the connecting strip 23 at the periphery of the first surface include a plurality of spaced-apart protrusions, so as to imitate a thread structure in the leather. The protrusions run through a whole surface of the connecting strip 23. The patch using this structure achieves a better leather imitation effect. Letter A is further provided on the first surface 20 in Embodiment 3, which will be described below in detail.

Optionally, the second surface 30 is a plane as a whole. Alternatively, the coupling portion is a plane, and a region other than the coupling portion in the second surface 30 is a concave. In a possible implementation, since the second surface is the plane as a whole, the second surface is adhered on the cosmetic container, the adhesive strength between the patch and the cosmetic container is high, and the patch does not fall off easily. In another possible implementation, only the coupling portion is the plane, and the remaining region of the second surface is the concave. That is, the thickness at each position of the bump 21 is the same. The patch having this structure is easily formed by the injection molding, thereby facilitating the industrial production.

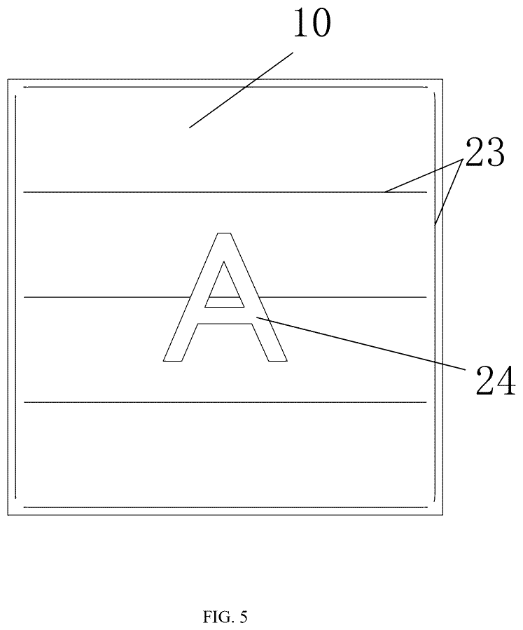

Embodiment 2: As shown in FIG. 5 to FIG. 8, symbol 24 is provided on the first surface 20. The symbol 24 is recessed toward the second surface 30, or the symbol 24 is protruded from the bump 21. Concerning that the symbol 24 is recessed toward the second surface 30, consistent grooves are formed in the first surface 20. The consistent grooves are formed into the symbol 24 having a certain meaning. The symbol may be any pattern. Optionally, the symbol 24 is a letter, a figure, a Chinese character or another special symbol. The symbol 24 is integrally formed with the patch substrate 10 through the injection molding. Optionally, the symbol 24 may be a single symbol, and may also be a combination formed by a plurality of symbols. The symbol 24 in FIG. 5 is A. In actual application, the letter A may be made into any picture. The symbol 24 may be any capital letter or small letter, figure, Chinese character or another special symbol. The symbol is formed directly in molding of the patch substrate 10, and thus is manufactured simply and conveniently. The symbol on the patch may be a pattern popular to consumers, and may also be a character with a special meaning, thereby meeting diverse demands of the consumers. In another possible implementation, a corresponding insert may be inlaid or adhered in each of the grooves formed into the symbol 24. In other implementations, the symbol 24 may also be protruded. Concerning that the symbol 24 is protruded from the bump 21, the symbol is higher than the first surface 20, and can be touched by the consumers, such that the whole structure of the patch is more stereoscopic and more novel.

When the symbol 24 is recessed toward the second surface 30, the deepest position of the recess 22 is coplanar with an upper surface of the symbol 24, so as to form a leather texture to be more similar to the imitation leather. The upper surface of the symbol 24 is a smooth and flat plane.

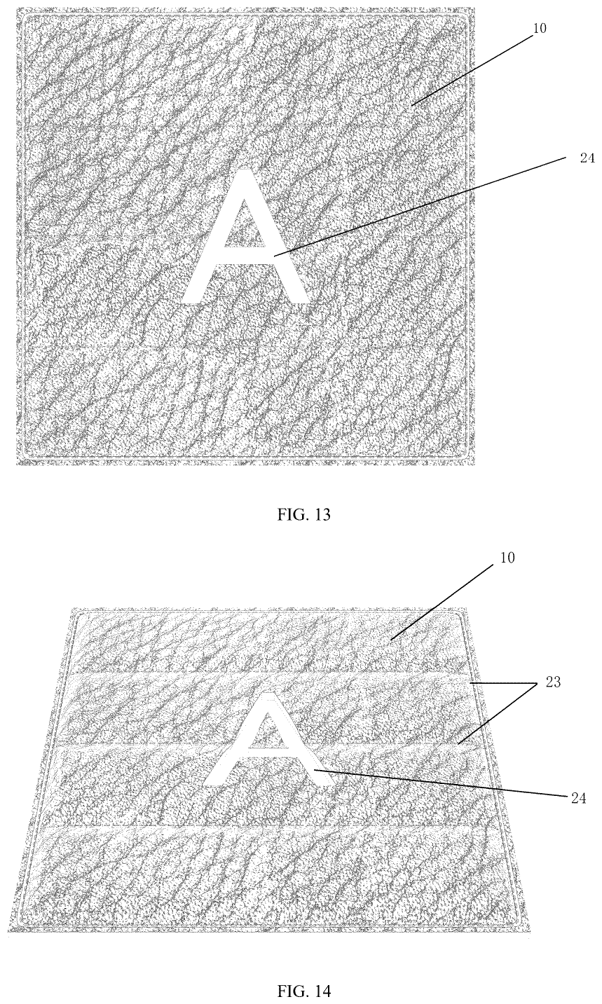

Embodiment 4: As shown in FIG. 13 and FIG. 14, a leather grain is provided on the first surface 20. Optionally, fine leather grains are arranged on the whole first surface 20. In manufacture, the mold is textured to obtain the leather grain on the first surface. There are laser texturing, and chemical etching for texturing. Different textured patterns are designed as needed, thereby obtaining the desired leather grain.

The patch substrate 10 is a patch substrate made of a TPU material, a patch substrate made of a PP material, a patch substrate made of a PVC material or a patch substrate made of a PET material. The TPU is thermoplastic polyurethane, the PET is polyethylene terephthalate, the PP is polypropylene, and the PVC is polyvinyl chloride.

Optionally, the patch substrate 10 is the patch substrate made of the TPU material. The TPU material has a density of 1.0 g/cm³ to 1.3 g/cm³, Shore hardness of 60 A to 75 A, a tensile strength of 10 MPa to 20 MPa, a 100% modulus of 1.5 MPa to 2.5 MPa, a 300% modulus of 4 MPa to 6 MPa, an elongation at break of 600% to 800%, a tear strength of 60 KN/m to 70 KN/m, wear resistance of 85 mm³ to 95 mm³, and a glass transition temperature of −45° C. to −40° C. Test standard for all indexes of the TPU material are as follows: The ASTM D792 standard is used for the density. The ASTM D2240 standard is used for the Shore hardness. The ASTM D412 standard is used for the tensile strength, the 100% modulus, 300% modulus and the tear strength. The ASTM D624 standard is used for the tear strength. The DIN53516 standard is used for the wear resistance. The differential scanning calorimetry (DSC) is used for the glass transition temperature Tg under a condition of 10° C./min. With the above features, the TPU material can be manufactured into the patch with the leather touch. In an embodiment, the TPU material has the following properties: Physical properties: The density is 1.18 g/cm³, and the Shore hardness is 66 A. Mechanical properties: The tensile strength is 17 MPa, the 100% modulus is 2 MPa, the 300% modulus is 5 MPa, the elongation at break is 750%, the tear strength is 65 KN/m, and the wear resistance is 90 mm³. Thermal property: The glass transition temperature is −42° C.

The present disclosure further provides a mold. The mold is configured to manufacture the patch for a cosmetic container. The patch is formed once through injection molding. That is, the patch substrate 10, the bump 21, the recess 22 and the connecting strip on the patch substrate, the protrusion on the connecting strip, the symbol, the leather grain and other features are formed once through the injection molding. Therefore, the manufacturing process is simple. The connecting strip, the protrusion on the connecting strip, the symbol, the leather grain and other features may be combined freely in the specific implementation, and are not limited to the above four embodiments only.

It should be noted that those of ordinary skill in the art can further make variations and improvements without departing from the conception of the present disclosure. These variations and improvements all fall within the protection scope of the present disclosure. Therefore, the protection scope of the present disclosure shall be subject to the appended claims.

What is claimed is:

1. A patch for a cosmetic container, comprising a patch substrate formed integrally by a plastic material through injection molding, wherein the patch substrate-comprises a first surface and a second surface, wherein the first surface and the second surface are opposite to each other; the first surface comprises bumps and recesses, wherein the bumps and the recesses are arranged alternately; a projection of the recess on the second surface is a coupling portion; and the coupling portion is configured to couple the patch and the cosmetic container.

2. The patch for the cosmetic container according to claim 1, wherein the bump and the recess adjacent to each other are connected together, and a connecting strip is provided at a deepest position of the recess.

3. The patch for the cosmetic container according to claim 2, wherein a combination of the bump and the recess is a linear structure, a V-shaped structure, a W-shaped structure, a zigzag structure or a wavy structure.

4. The patch for the cosmetic container according to claim 3, wherein the bump and the recess are arranged along a length direction of the patch substrate; and the bump and the recess run through an entire or a part of the patch substrate in the length direction.

5. The patch for the cosmetic container according to claim 2, wherein a circle of connecting strip is provided at an edge of a periphery of the first surface.

6. The patch for the cosmetic container according to claim 2, wherein an upper surface of the connecting strip is a smooth and flat plane, or the upper surface of the connecting strip comprises a plurality of spaced-apart protrusions.

7. The patch for the cosmetic container according to claim 1, wherein the second surface is a plane as a whole, or the coupling portion is a plane, and a region other than the coupling portion in the second surface is a concave.

8. The patch for the cosmetic container according to claim 1, wherein a symbol is provided on the first surface, the symbol is recessed toward the second surface, or the symbol is protruded from the bump.

9. The patch for the cosmetic container according to claim 8, wherein when the symbol is recessed toward the second surface, a deepest position of the recess- is coplanar with an upper surface of the symbol, and the upper surface of the symbol- is a smooth and flat plane.

10. The patch for the cosmetic container according to claim 1, wherein a leather grain is provided on the first surface.

11. The patch for the cosmetic container according to claim 1, wherein the patch substrate is a patch substrate made of a thermoplastic polyurethane (TPU) material, a patch substrate made of a polypropylene (PP) material, a patch substrate made of a polyvinyl chloride (PVC) material or a patch substrate made of a polyethylene terephthalate (PET) material.

12. The patch for the cosmetic container according to claim 11, wherein the patch substrate is the patch substrate made of the TPU material, and the TPU material has a density of 1.0 g/cm³ to 1.3 g/cm³, Shore hardness of 60 A to 75 A, a tensile strength of 10 MPa to 20 MPa, a 100% modulus of 1.5 MPa to 2.5 MPa, a 300% modulus of 4 MPa to 6 MPa, an elongation at break of 600% to 800%, a tear strength of 60 KN/m to 70 KN/m, wear resistance of 85 mm³ to 95 mm³, and a glass transition temperature of −45° C. to −40° C.

13. A mold, wherein the mold is configured to manufacture the patch for the cosmetic container according to claim 1.

14. The patch for the cosmetic container according to claim 3, wherein an upper surface of the connecting strip is a smooth and flat plane, or the upper surface of the connecting strip comprises a plurality of spaced-apart protrusions.

15. The patch for the cosmetic container according to claim 4, wherein an upper surface of the connecting strip is a smooth and flat plane, or the upper surface of the connecting strip comprises a plurality of spaced-apart protrusions.

16. The patch for the cosmetic container according to claim 5, wherein an upper surface of the connecting strip is a smooth and flat plane, or the upper surface of the connecting strip comprises a plurality of spaced-apart protrusions.

17. The mold according to claim 13, wherein in the patch for the cosmetic container, the bump and the recess adjacent to each other are connected together, and a connecting strip is provided at a deepest position of the recess.

18. The mold according to claim 17, wherein in the patch for the cosmetic container, a combination of the bump and the recess is a linear structure, a V-shaped structure, a W-shaped structure, a zigzag structure or a wavy structure.

19. The mold according to claim 18, wherein in the patch for the cosmetic container, the bump and the recess are arranged along a length direction of the patch substrate; and the bump and the recess run through an entire or a part of the patch substrate in the length direction.

20. The mold according to claim 17, wherein in the patch for the cosmetic container, a circle of connecting strip is provided at an edge of a periphery of the first surface.
